(19) United States
(12) Patent Application Publication
(10) Pub. No.: US 2013/0176112 A1
(43) Pub. Date: Jul. 11, 2013

(54) SYSTEM AND METHOD FOR MANAGING SPORT ACTIVITIES

(71) Applicant: Feng-An Yu, Taichung City (TW)

(72) Inventor: Feng-An Yu, Taichung City (TW)

(21) Appl. No.: 13/734,989

(22) Filed: Jan. 6, 2013

Related U.S. Application Data
(63) Continuation-in-part of application No. 13/594,889, filed on Aug. 27, 2012.

(30) Foreign Application Priority Data
Jan. 6, 2012 (TW) 101200312
Apr. 12, 2012 (TW) 10126655

(51) Int. Cl. G08C 17/02

(52) U.S. Cl. CPC G08C 17/02
USPC 340/10.1

(57) ABSTRACT

An approach is provided for a system for managing sport activities, which comprises at least one identifier, multiple transceivers and a server. The identifier is configured for inspecting each player in a sport activity, and has a serial number. The transceivers are located in specific spots of the sport activity, and each transceiver comprises a short-range radio signal receiver being configure for reading the serial number of the identifier, and a long-range radio signal transmitter the serial number of identifier and a timestamp when the serial number is obtained. The server is located distant from the sport activity, receives the timestamp and serial number from the transceiver, and uploads the timestamps with the corresponded player.

### FIELD OF THE INVENTION

Embodiments of the invention relate to a system and method for real-time data management, especially to a system and method for managing sport activities.

### BACKGROUND

ESPN is a global cable television network focusing on sports-related programming including live an pre-taped event telecast, sports talk shows and other alike program.

Typically, information about registration, scores, result and broadcasting of the sport activity cannot be obtained from a single source. Thus, it is difficult to provide such information as a whole to sports fans and/or players. It is very inconvenient. Further, sports fans and/or players cannot get real time information about more than one sporting event being played at different venues at the same time.

Accordingly, there is a need for better information management that is able to provide a real-time broadcasting.

### SOME EXEMPLARY EMBODIMENTS

These and other needs are addressed by the invention, wherein an approach is provided for real-time broadcasting of a sport activity.

According to one aspect of an embodiment of the invention, a system for managing sport activities comprises at least one identifier, at least one transceiver and a server. The identifier is configured for inspecting each player in a sport activity, and has a serial number. The transceiver is located in specific spot of the sport activity, and comprises a short-range radio signal receiver being configure for reading the serial number of the identifier, and a long-range radio signal transmitter the serial number of identifier and a timestamp when the serial number is obtained. The server is located distant from the sport activity, receives the timestamp and serial number from the transceiver, and uploads the timestamps with the corresponded player.

According to another aspect of an embodiment of the invention, a system for managing sport activities comprises acts of providing a player's profile in associate to a serial number stored in the identifier; providing multiple transceivers at desired spots for receiving the identifier; generating a timestamp when the serial number of the identifier has received; and broadcasting and updating results of the player, wherein the result includes the player's profile and the timestamp

Therefore, the system and method are able to trace each player on the sport field in a real-time fashion, and records their result without any additional manual cost or complex data transactions.

### BRIEF DESCRIPTION OF THE DRAWINGS

The invention is illustrated by way of example, and not by way of limitation, in the figures of the accompanying drawings in which like reference numerals refer to similar elements and in which:

FIG. 1 is a diagram of a system for managing sport activities in accordance with an embodiment of the present invention;

FIG. 2 is a diagram of the system used in a jogging sport event;

FIG. 3A is a flow chart of a method for managing sport activities in accordance with an embodiment of the present invention;

FIG. 3B is a flow chart of a method for managing sport activities in accordance with another embodiment of the present invention;

FIG. 4 is a block diagram of the server in FIG. 1 in accordance with an embodiment of the present invention; and

FIG. 5 is a diagram of the transceiver in accordance with another embodiment of the present invention.

### DESCRIPTION OF THE PREFERRED EMBODIMENT

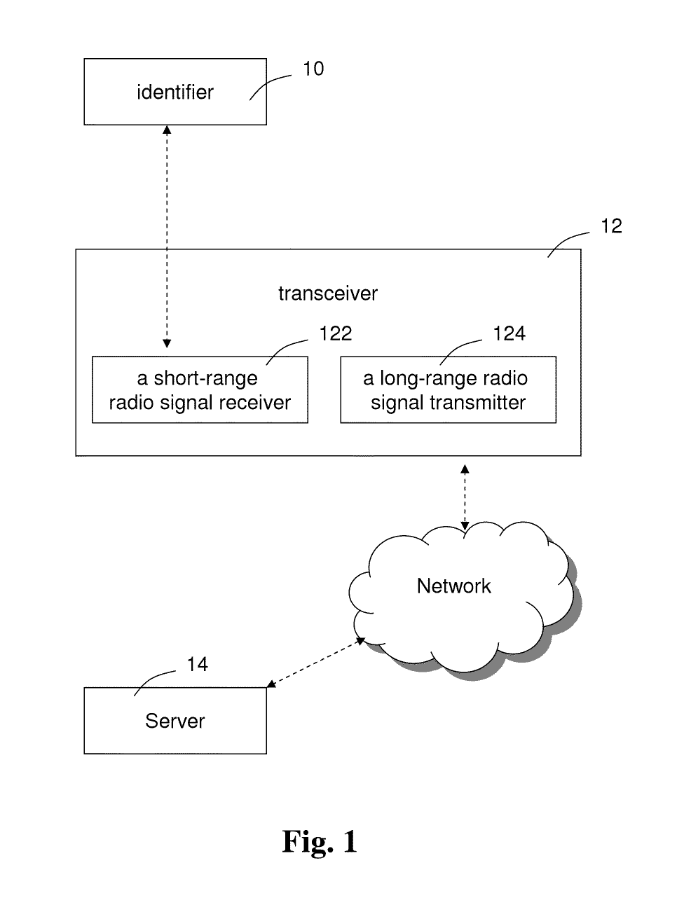

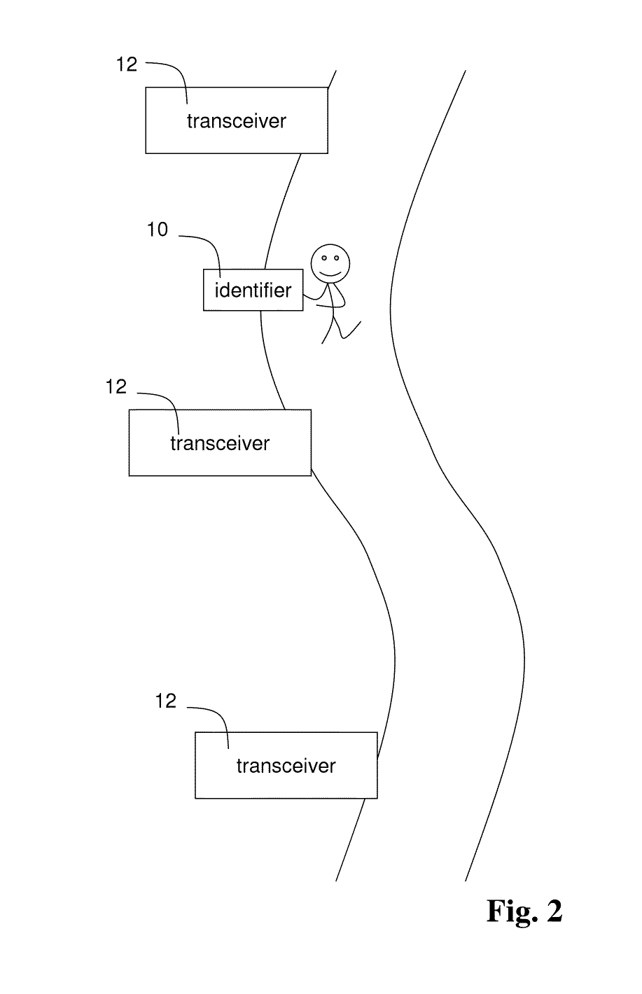

With reference to FIGS. 1 and 2, FIG. 1 is a diagram of a system for managing sport activities in accordance with an embodiment of the present invention, and FIG. 2 is a diagram of the system used in a jogging sport event. In this embodiment, the system comprises at least one identifier 10, at least one transceiver 12 and a server 14.

The identifier 10 is configured for inspecting each player in the sport activity, and may be a wearing object such as a wristwatch, a garment, a cup or a gadget for shoes. In one embodiment, the identifier 10 is a RFID (Radio Frequency Identification) tag with a unique serial number.

The transceivers 12 are located in specific spots for the sport activity, and each transceiver 12 comprises a short-range radio signal receiver 120 and a long-range radio signal (e.g. GSM (Global System for Mobile Communications) transmitter 122. In one embodiment, the short-range radio signal receiver 120 is a RFID (Radio Frequency Identification) reader that is able to emit a short-range radio signal that powers up the RFID tag (i.e. identifier 10), reads the serial number in the identifier 10, and records a timestamp when the serial number is obtained.

The server 14 is located distant from the sport activity, receives data from the transceivers 12 from the long-range radio signal transmitter 122, and uploads the timestamps with the corresponded player. The server 14 is able to identify the transceivers 12 to determine the spots of the sport activity.

It is noted that each long-range radio signal transmitter 122 of the transceiver 12 has its own IP address (e.g. via UMTS (Universal Mobile Telecommunication System) network), which is able to send the result directly to the remote server 14 and has benefits for flexible settings. However, due to the various communication protocols, the radio communication is not limited to GSM transmitter; it can also use protocol of TDMA (Time Division Multiple Access).

As shown in FIG. 2, assuming a sport activity is a marathon or a jogging event, the transceivers 12 are located at spots including a start point, check points and an end point. Accordingly, when the identifier 10 is worn by a person has passing a transceiver 12, the transceiver 12 instantaneously reads the serial number of the identifier 10 with the timestamp, and then transmit to the server 14. The server 14 updates each player's status once the data is received from the transceiver 12, which is indicative of a real-time broadcasting. In this manner, the system is able to trace each player on the sport field, and records their running result without any additional manual cost or complex data transactions.

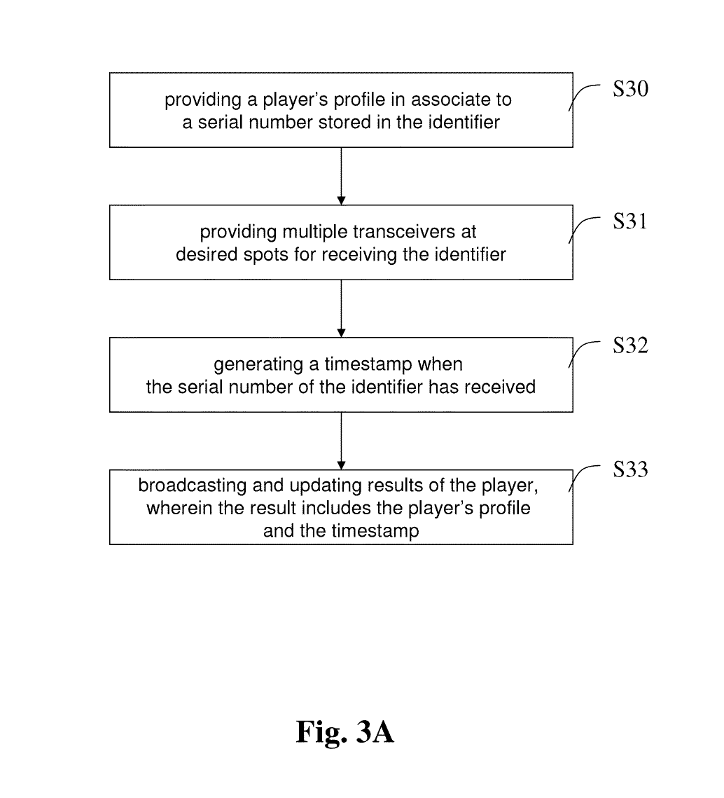

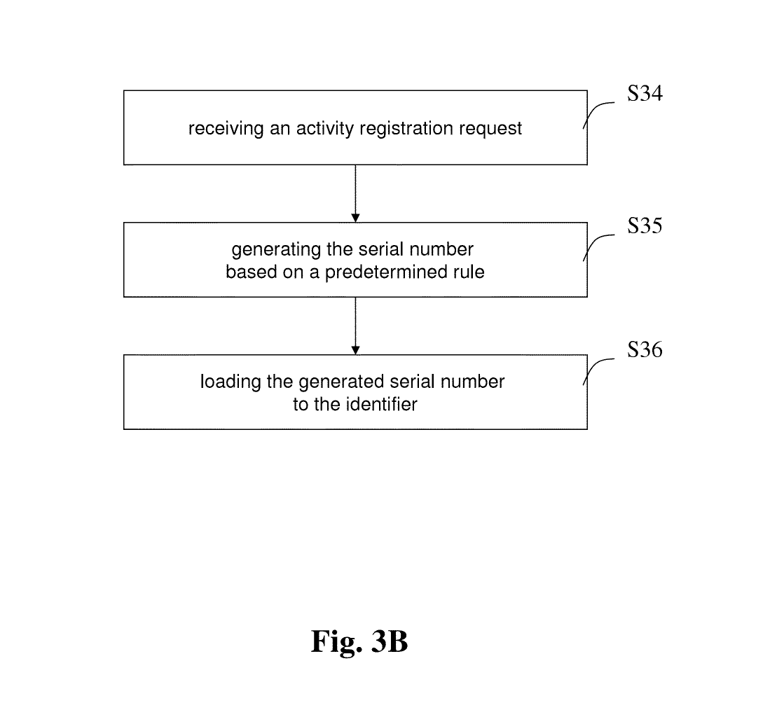

With reference to FIGS. 3A and 3B, Figures illustrate methods for managing sport activities. The system implements the method that comprises acts of S30 providing a player's profile in associate to a serial number stored in the identifier, S31 providing multiple transceivers at desired spots for receiving the identifier, S32 generating a timestamp when the serial number of the identifier has received, and S33 broadcasting and updating results of the player, wherein the result includes the player's profile and the timestamp.

In order to verify correct identity of the player associated with the serial number, the method further comprises acts of S34 receiving an activity registration request, S35 generating the serial number based on a predetermined rule, and S36 loading the generated serial number to the identifier.

In step S34, the activity registration request is generated when a person is interested to attend to a sport activity. If the person is an existent member, the server 14 will automatically add the person to the activity, and generate a serial number based on the predetermined rule. If the person is not existent member, the server 14 will lead the person to a member registrant.

In one embodiment, the predetermined rule for generating serial number has a relationship of the following table:

| Organization | | Date of | Residual |
|---|---|---|---|
| code | Player code | sport activity | code |
| 4444 | 01123456789 | 20130316 | 0 |

In this example, the combination of the serial number has 24 digits and at least comprises an organization code, a player code, and a date for the sport activity. Sine the serial number is unique and has the player code for each player, the server is able to identify the player by decoding the serial number and retrieve the player's profile according to the player code.

It is noted that the method and system for managing sport activities have superior advantages of multi-tasking which is able to manage, monitor and broadcast multiple activities at same time among different organizations and players.

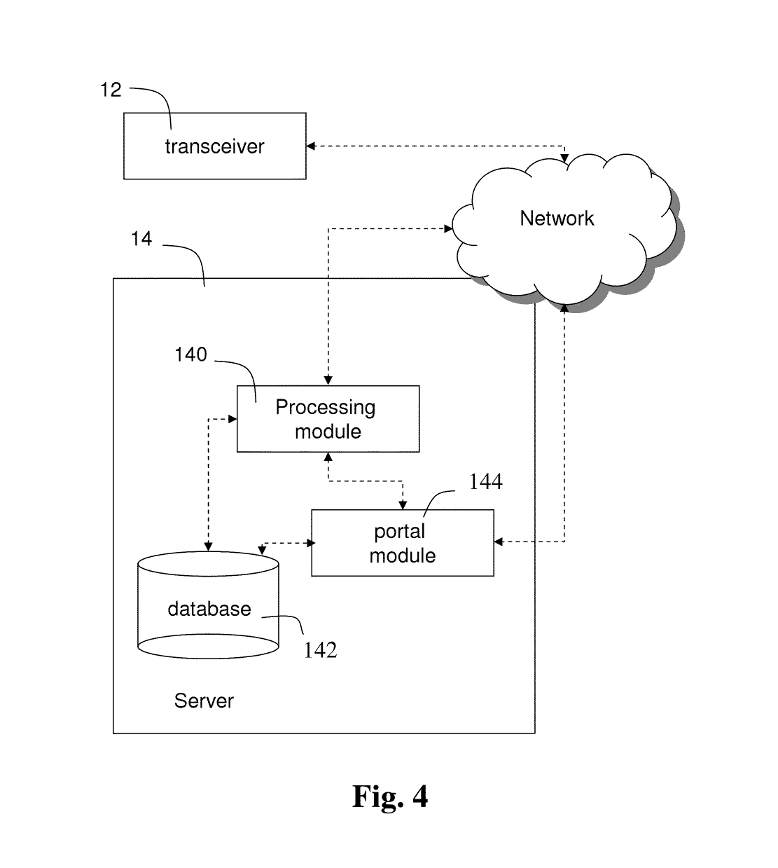

With reference to FIG. 4, FIG. 4 illustrates a block diagram of the server, which comprises a processing module 140, a database 142 and a portal module 144. The processing module 140 receives data including the serial number and the timestamp from the transceiver 12, uses the received serial number to retrieve player's profile from the database 142, and uploads the timestamps with corresponded players to the portal module 144. The portal module 144 may be a web-based interface (e.g. website) that allows users to access the statuses of the sport activities via internet.

A recurring game may be created and/or a series of games may be created. For example, a season may be created for a team sport that includes a plurality of games. The season may include a plurality of teams that participate in a league and more occasions. A tournament may also be created for a sporting event. The tournament may include a group of teams that against one another. The winner of the tournament may be given a prize or other award. The database 142 is able to record results after every sport activity, and the portal module 144 represents and ranks the result for each player to enhance better entertainment.

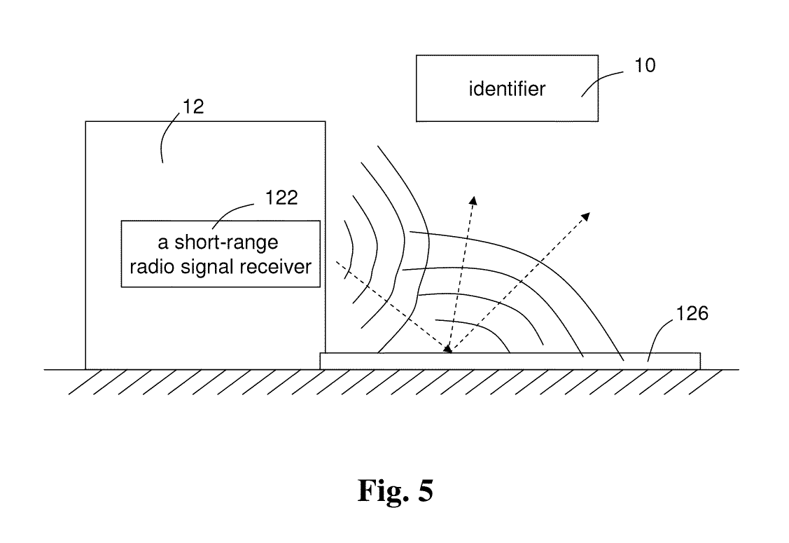

With reference to FIG. 5, FIG. 5 shows another embodiment of the transceiver in accordance with the present invention. In this embodiment, the transceiver 12 further comprises a metal plate 126 located on the ground. The metal plate 126 has a rough surface and is configured for reflecting signals from the ground. In one embodiment, the metal plate 126 is made from multiple interlaced metal strips.

Accordingly, as shown in FIG. 5, the short-range radio signal receiver 122 emits the short-range radio signal to power up the identifier 10, which is outward horizontally. Due to the rough surface of the metal plate 126, the metal plate 126 converts the directional short-range radio signal to non-directional signal waveforms. In this manner, the reflected non-directional signals provides better signal coverage that avoids failure of detecting the identifier 10.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A system for managing sport activities comprising:
at least one identifier being configured for inspecting each player in a sport activity, and having a serial number;
at least one transceiver being located in specific spots of the sport activity, and comprising
a short-range radio signal receiver being configure for reading the serial number of the identifier; and
a long-range radio signal transmitter the serial number of identifier and a timestamp when the serial number is obtained; and
a server being located distant from the sport activity, receiving the timestamp and serial number from the long-range radio signal transmitter of the transceiver, and uploads the timestamps with the corresponded player.

2. The system as claimed in claim 1, wherein the identifier is a RFID tag, and the short-range radio signal receiver of the transceiver is a RFID reader.

3. The system as claimed in claim 1, wherein the long-range radio signal transmitter of the transceiver is a GSM transmitter that transmits data to the server via a UMTS network.

4. The system as claimed in claim 1, wherein the long-range radio signal transmitter of the transceiver is a TDMA transmitter.

5. The system as claimed in claim 1, wherein the identifier is a wearing object selected from a group consisting of a wristwatch, a garment, a cup and a gadget for shoes.

6. The system as claimed in claim 1, wherein the server comprises a processing module, a database and a portal module, wherein the processing module receives data including the serial number and the timestamp from the transceiver, uses the received serial number to retrieve player's profile from the database, and uploads the timestamps with corresponded players to the portal module.

7. The system as claimed in claim 6, wherein the portal module is a web-based interface that allows users to access the statuses of the sport activities via internet.

8. The system as claimed in claim 1, wherein the transceiver further comprises a metal plate located on the ground, and the metal plate has a rough surface that is configured for reflecting signals generated from the short-range radio signal receiver.

9. The system as claimed in claim 8, wherein the metal plate is made from multiple interlaced metal strips.

10. A method for managing sport activities, comprising:
providing a player's profile in associate to a serial number stored in the identifier;
providing multiple transceivers at desired spots for receiving the identifier;
generating a timestamp when the serial number of the identifier has received; and
broadcasting and updating results of the player, wherein the result includes the player's profile and the timestamp.

11. The method as claimed in claim 10, further comprising:
receiving an activity registration request;
generating the serial number based on a predetermined rule; and
loading the generated serial number to the identifier.

12. The method as claimed in claim 11, wherein the serial number is a combination of an organization code, a player code, and a date for the sport activity.
